(19) United States
(12) Patent Application Publication
(10) Pub. No.: US 2016/0227151 A1
(43) Pub. Date: Aug. 4, 2016

(54) DISPLAY APPARATUS, REMOTE CONTROL APPARATUS, REMOTE CONTROL SYSTEM AND CONTROL METHOD THEREOF

(71) Applicant: SAMSUNG ELECTRONICS CO., LTD., Suwon-si (KR)

(72) Inventors: Joon-ho PHANG, Seoul (KR); Na-young KOH, Seoul (KR); Jean-Christophe NAOUR, Anyang-si (KR); Kwan-min LEE, Seoul (KR)

(73) Assignee: SAMSUNG ELECTRONICS CO., LTD., Suwon-si (KR)

(21) Appl. No.: 15/014,489

(22) Filed: Feb. 3, 2016

(30) Foreign Application Priority Data
Feb. 3, 2015 (KR) 10-2015-0016901

(51) Int. Cl. H04N 5/44; G06F 3/0488

(52) U.S. Cl. CPC H04N 5/4403; G06F 3/0488

(57) ABSTRACT

A remote control apparatus for controlling a display apparatus, the remote control apparatus including a communicator configured to perform communication with the display apparatus; a user interface provided with a plurality of control surfaces each mapped to each of a plurality of display areas provided on a screen of the display apparatus; and a processor configured, in response to a user command being input through at least one of the plurality of control surfaces, to transmit a signal for controlling a display area mapped to a control surface to which the user command has been input.

### CROSS-REFERENCE TO RELATED APPLICATIONS

This application claims priority from Korean Patent Application No. 10-2015-0016901, filed on Feb. 3, 2015, in the Korean Intellectual Property Office, the disclosure of which is incorporated herein by reference in its entirety.

### BACKGROUND

1. Field

Apparatuses and methods consistent with the embodiments relate to a display apparatus, remote control apparatus, remote control system and control method thereof, and more particularly, to a display apparatus that may be controlled remotely, a remote control apparatus, remote control system, and a control method thereof.

2. Description of the Related Art

In general, a display apparatus such as a digital TV is provided with a remote control apparatus configured to control operations of the display apparatus remotely for user convenience. Recent display apparatuses provide various contents such as broadcast contents, VOD contents, and photo contents and the like, and the remote control apparatus being provided together with the display apparatus may perform various functions to provide such contents with convenience and effectiveness.

However, a conventional remote control apparatus still has a uniform user interface structure including a channel button, volume button, and navigation key such as an arrow for selecting a menu, and thus there is difficulty in manipulation in performing various functions being provided in the display apparatus.

For example, the display apparatus may provide a plurality of UIs for selecting various functions and contents, the plurality of UIs being configured to have one of various structures. Therefore, there is difficulty for the user to perform pressing manipulations by selecting buttons of four directions in the remote control numerous times while checking the buttons provided in the remote control apparatus to select a desired function or content.

Accordingly, it is required to seek a way to control a display apparatus more intuitively and conveniently using the remote control apparatus.

### SUMMARY

Additional aspects and/or advantages will be set forth in part in the description which follows and, in part, will be apparent from the description, or may be learned by practice of the embodiments.

Exemplary embodiments overcome the above disadvantages and other disadvantages not described above. Also, the embodiments are not required to overcome the disadvantages described above, and an exemplary embodiment may not overcome any of the problems described above.

Various embodiments of the present disclosure are directed to a display apparatus that provides easy manipulating experience so that it is possible to control a UI screen being provided in a display apparatus more intuitively, a remote control apparatus, remote control system and a control method thereof.

According to an embodiment of the present disclosure, there is provided a remote control apparatus for controlling a display apparatus, the remote control apparatus including a communicator configured to perform communication with the display apparatus; a user interface provided with a plurality of control surfaces each mapped to each of a plurality of display areas provided on a screen of the display apparatus; and a processor configured, in response to a user command being input through at least one of the plurality of control surfaces, to transmit a signal for controlling a display area mapped to a control surface to which the user command has been input.

The user interface may have a structure where the plurality of control surfaces are physically divided.

The user interface may have an arch structure where a second control surface adjacent to a first control surface forms a predetermined angle with the first control surface, and a third control surface adjacent to the second control surface forms a predetermined angle with the second control surface.

The processor may transmit a signal for controlling a UI (User Interface) screen displayed on a display area mapped with a control surface where the user command has been input of among a plurality of UI screens provided in each of the plurality of display areas.

The remote control apparatus may further include a mode state detector configured to determine an arrangement state of the remote control apparatus, and to detect a length mode state or width mode state according to the determined arrangement state, wherein the processor controls such that a UI screen corresponding to the detected mode state is displayed on each of the plurality of control surfaces.

The user interface may include a light emitter provided on a bottom part of the plurality of control surfaces, and the processor may control the light emitter such that an item representing a function corresponding to the detected mode state emits light and provides a UI screen corresponding to each of the plurality of control surfaces.

The plurality of control surfaces may include at least one of a key pad, touch pad and track pad.

According to another embodiment of the present disclosure, there is provided a method for controlling a remote control apparatus having a plurality of control surfaces each mapped with a plurality of display areas provided on a screen of a display apparatus, the method including receiving input of a user command through at least one of the plurality of control surfaces; and transmitting a signal for controlling the display area mapped to the control surface to which the user command has been input according to the user command to the display apparatus.

The transmitting may involve transmitting a signal for controlling a UI screen displayed on a display area mapped with a control surface to which the user command has been input of among UIs provided in each of the plurality of display areas.

The method may further include determining an arrangement state of the remote control apparatus, and detecting a length mode state or width mode state according to the determined arrangement state; and controlling a UI screen corresponding to the detected mode state to be displayed on each of the plurality of control surfaces.

According to another embodiment of the present disclosure, there is provided a display apparatus being controlled by a remote control apparatus, the display apparatus including a display configured to provide a screen; a communicator configured to perform communication with a remote control apparatus provided with a plurality of control surfaces being mapped to each of a plurality of display areas provided on the screen; and a processor configured, in response to receiving a control signal corresponding to a user command being input through at least one of the plurality of control surfaces provided in the remote control apparatus, to control a display area corresponding to the received control signal of among the plurality of display areas.

The processor may control a UI screen corresponding to a control signal received from the remote control apparatus of among a plurality of UI screens provided in each of the plurality of display areas.

The processor may divide the screen into a plurality of display areas in a length direction or width direction based on attributes of a UI screen to be displayed on the screen and provides the UI screen.

The processor, in response to receiving a control signal according to a touch input of crossing the plurality of control surfaces from the remote control apparatus, may control such that different UI screens are sequentially displayed on each of the plurality of display areas.

The processor, in response to receiving a control signal according to a press input from the remote control apparatus, may control such that at least a portion of the different UI screens are displayed at the same time on each of the plurality of display areas based on the press input method.

According to another embodiment of the present disclosure, there is provided a method for controlling a display apparatus, the method including performing communication with a remote control apparatus provided with a plurality of control surfaces each mapped to a plurality of display areas provided on a display screen; and in response to receiving a control signal corresponding to a user command being input through at least one of the plurality of control surfaces provided in the remote control apparatus, controlling a display area corresponding to the received control signal of among the plurality of display areas.

The controlling may control a UI (User Interface) screen corresponding to the control signal received from the remote control apparatus of among a plurality of UI screens provided on each of the plurality of display areas.

The method may further include dividing the screen into a plurality of display areas in a length direction or width direction based on attributes of a UI screen to be displayed on the screen.

The controlling may involve, in response to receiving a control signal according to a touch input of crossing the plurality of control surfaces from the remote control apparatus, controlling such that different UI screens are sequentially displayed on each of the plurality of display areas.

According to an embodiment of the present disclosure, there is provided a remote control system including a remote control apparatus and display apparatus, the remote control system including the remote control apparatus provided with a plurality of control surfaces each mapped to each of a plurality of display areas provided on a screen of the display apparatus, and configured to transmit a control signal corresponding to a user command being input through at least one of the plurality of control surfaces to the display apparatus; and a display apparatus configured, in response to receiving the control signal, to control a display area corresponding to the received control signal of among the plurality of display areas.

According to another embodiment of the present disclosure, there is provided a display system including a display having plural controllable display areas, a remote control device having control surfaces, each control surface corresponding to one of the areas and a controller controlling one of the areas corresponding to a user interaction with a corresponding one of the control surfaces.

Each of the control surfaces may include user controllable function surfaces to activate one of plural functions for the corresponding one of the areas.

The display areas may be divided into subareas along vertical and horizontal axes, and one axis corresponds to the functions and another axis corresponds to operations of the functions.

The controller may control the areas to display graphical user interfaces of corresponding control surfaces touched by a user in a constant touch crossing the regions.

An orientation of the remote control device controls the orientation of the regions of the display screen.

According to another embodiment of the present disclosure, there is provided a non-transitory computer readable medium storing a process for controlling a display apparatus, the process including performing communication with a remote control apparatus provided with a plurality of control surfaces each mapped to a plurality of display areas provided on a display screen and in response to receiving a control signal corresponding to a user command being input through at least one of the plurality of control surfaces provided in the remote control apparatus, controlling a display area corresponding to the control signal of among the plurality of display areas.

According to the various aforementioned embodiments of the present disclosure, it is possible to provide physically intuitive manipulating experience regarding a UI being provided on the display screen, thereby improving user convenience.

### BRIEF DESCRIPTION OF THE DRAWINGS

The above and/or other aspects will be more apparent by describing certain exemplary embodiments with reference to the accompanying drawings, in which:

FIG. 1 is a view for explaining an embodiment example of a remote control apparatus according to an embodiment of the present disclosure;

FIG. 2 is a block diagram schematically illustrating a configuration of a remote control apparatus according to an embodiment of the present disclosure;

FIG. 3 is a block diagram schematically illustrating a configuration of a display apparatus according to an embodiment of the present disclosure;

FIG. 4 is a view for explaining mapping of a plurality of control surfaces and a display area according to an embodiment of the present disclosure;

FIG. 5 is a view for explaining changing a function according to an arrangement state of a remote control apparatus according to an embodiment of the present disclosure;

FIG. 6 is a view for explaining mapping of a plurality of control surfaces and a display area according to another embodiment of the present disclosure;

FIGS. 7a and 7b are views for explaining in detail mapping a plurality of control surfaces and a display area according to an embodiment of the present disclosure;

FIGS. 8a to 12 are views for explaining a method for providing a UI screen in a plurality of display areas according to another embodiment of the present disclosure;

FIG. 13 is a view for explaining a method for inputting a letter using a remote control apparatus according to an embodiment of the present disclosure;

FIG. 14 is a block diagram illustrating in detail a configuration of a display apparatus according to an embodiment of the present disclosure;

FIG. 15 is a view illustrating a remote control apparatus realized in various methods according to various embodiments of the present disclosure;

FIG. 16 is a view illustrating a user terminal apparatus and a remote control apparatus realized as a cover according to an embodiment of the present disclosure;

FIG. 17 is a flowchart for explaining a control method of a remote control apparatus according to an embodiment of the present disclosure; and

FIG. 18 is a flowchart for explaining a control method of a display apparatus according to an embodiment of the present disclosure.

### DETAILED DESCRIPTION

Reference will now be made in detail to the embodiments, examples of which are illustrated in the accompanying drawings, wherein like reference numerals refer to the like elements throughout. The embodiments are described below to explain the embodiments by referring to the figures.

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the embodiments. Thus, it is apparent that the exemplary embodiments can be carried out without those specifically defined matters. Also, well-known functions or constructions are not described in detail since they would obscure the embodiments with unnecessary detail.

The exemplary embodiments of the present disclosure may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. Also, well-known functions or constructions are not described in detail since they would obscure the disclosure with unnecessary detail.

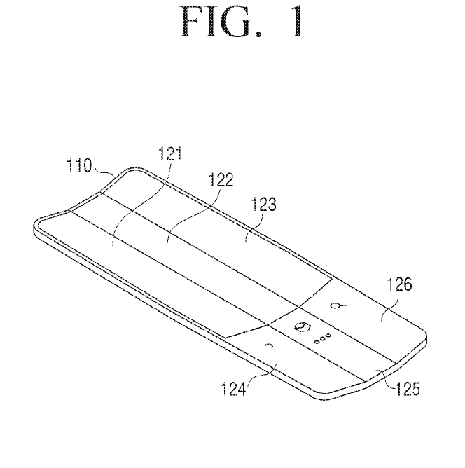

FIG. 1 is a view for explaining an embodiment example of a remote control apparatus according to an embodiment of the present disclosure.

The remote control apparatus 100 is a configuration for controlling operations of a display apparatus. In an embodiment of the present disclosure, the remote control apparatus 100 may be a remote controller configured to emit an infrared ray of a predetermined frequency to a display apparatus to control operations of the display apparatus. Herein, the display apparatus may receive the emitted infrared ray, convert the infrared ray into electric signals corresponding to the frequency of the infrared ray, to perform various operations such as converting a channel and adjusting volume and the like.

Meanwhile, the user may request the display apparatus to provide a content using the remote control apparatus 100, and control the display apparatus providing the content. For example, the user may select a channel using the remote control apparatus 100, and the display apparatus may display a content of the selected channel through the remote control apparatus 100.

The remote control apparatus 100 includes a plurality of control surfaces. The user may perform various control operations of selecting a channel of the display apparatus, adjusting volume, selecting an external input mode, and executing an application program and the like using the plurality of control surfaces. For this purpose, the plurality of control surfaces may be realized as at least one of a key pad including various function keys, number keys and special keys; a touch pad for sensing movements of fingers; and a track pad.

Herein, the plurality of control surfaces may each be mapped to each of a plurality of display areas or display regions provided on the screen of the display apparatus, and control each display area using the key pad, touch pad and track pad provided in each of the plurality of control surfaces.

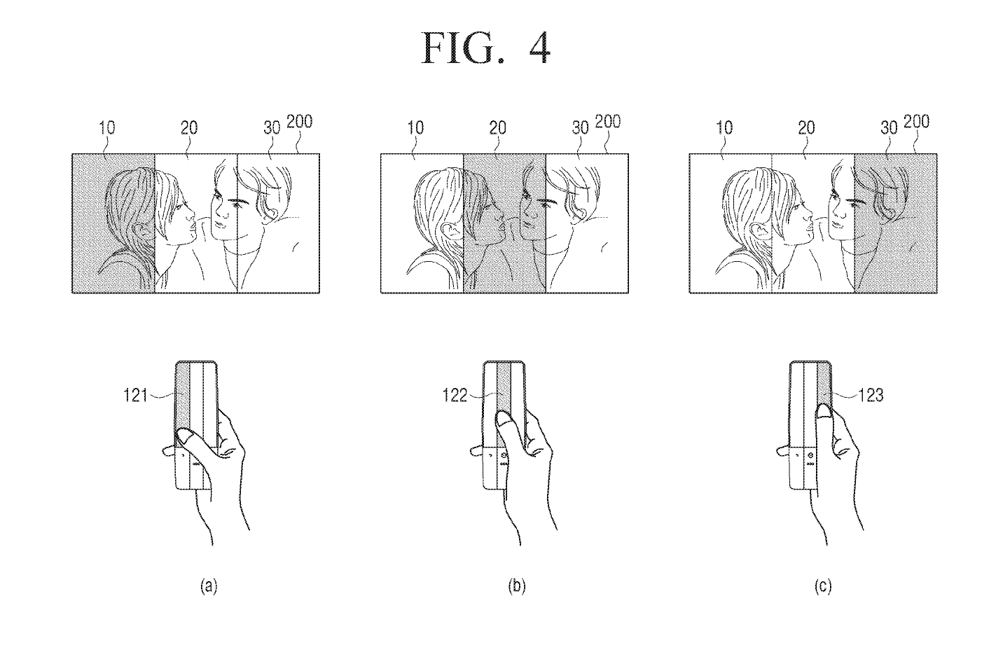

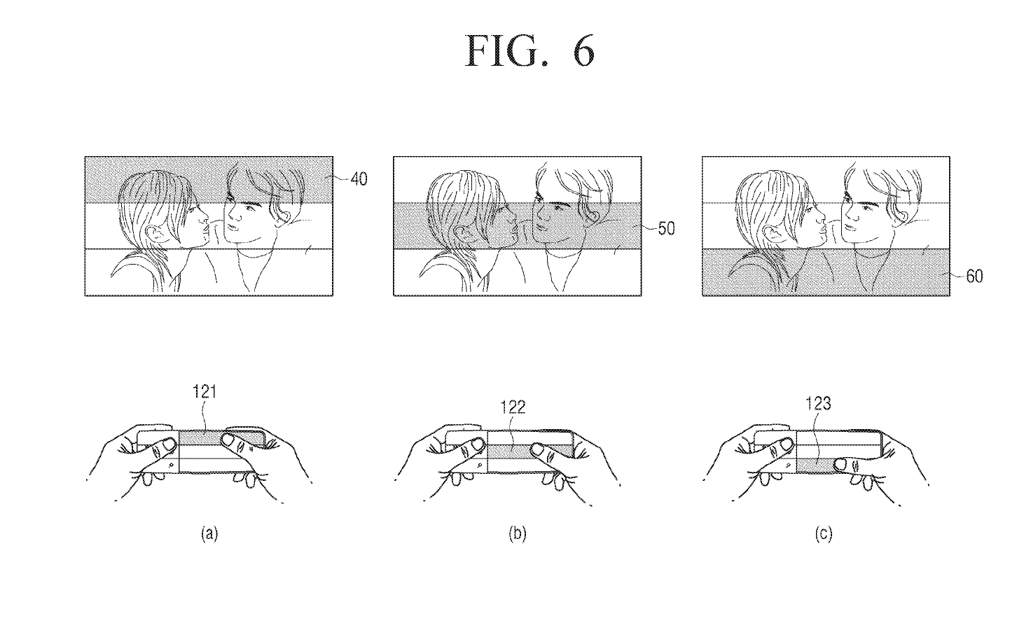

For example, a user interface 120 may be configured as a first control surface 121, second control surface 122 and third control surface 123 as illustrated in FIG. 1, in which case three areas of the screen of the display apparatus may each be mapped to a control surface. Herein, the plurality of display areas provided on the screen of the display apparatus may be matched to a layout of the plurality of control surfaces 121˜123 of the user interface 120. More specific explanation thereof will be made hereinafter with reference to FIGS. 4 and 6.

Meanwhile, the plurality of control surfaces 121˜123 may have a physically divided structure. That is, the physically divided plurality of control surfaces 121˜123 may serve a function of enabling the user to input a command desired by the user by only touching. Herein, the physically divided structure may be for example a structure including a groove between the plurality of control surfaces 121˜123, or a structure where the plurality of control surfaces 121˜123 protrude on a plane. However, there is no limitation thereto, and thus the physically divided structure may be one of various structures that enable differentiating between each control surface by only touching.

The user terminal apparatus 100 may sense a touch interaction on each of the plurality of control surfaces 12˜123, generate a signal corresponding to the touch interaction, and transmit a corresponding signal to the display apparatus through the communicator 110, thereby controlling the display apparatus.

More specifically, the user terminal apparatus 100 may generate a direction signal corresponding to a direction of the touch interaction, and control a function corresponding to the display apparatus according to the direction signal. For example, the user terminal apparatus 100 may perform a function of volume up according to an upward direction signal generated according to the upward direction touch interaction.

Furthermore, as illustrated in FIG. 1, the user terminal apparatus 100 may be provided with keypads 124˜126 for executing a predetermined function besides the plurality of control surfaces 121˜123.

Furthermore, the plurality of control surfaces 121˜123 may have an arch structure of a certain gradient. More specifically, as illustrated in FIG. 1, the plurality of control surfaces 121˜123 may be configured to have an arch structure where a second control surface adjacent to a first control surface forms a predetermined angle with the first control surface, and a third control surface adjacent to the second control surface forms a predetermined angle with the second control surface. Accordingly, it is possible to differentiate each of the plurality of control surfaces 121˜123 by touching without even seeing the user terminal apparatus 100.

Meanwhile, the user terminal apparatus 100 may be embodied as one of various formats such as a portable mobile phone, PMP, PDA, and notebook and the like.

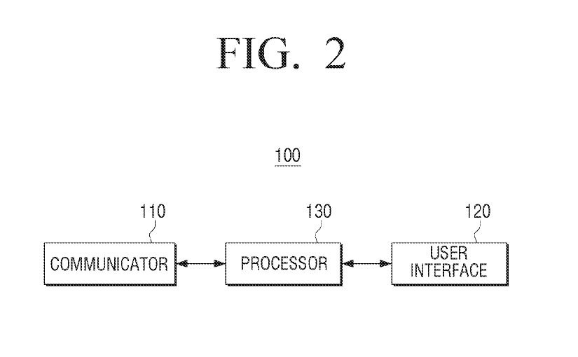

FIG. 2 is a block diagram schematically illustrating a configuration of a remote control apparatus or device according to an embodiment of the present disclosure.

According to FIG. 2, the remote control apparatus according to an embodiment of the present disclosure includes a communicator 110, user interface 120 and controller or processor 130.

The communicator 110 is a configuration for performing communication with the display apparatus 200. More specifically, the communicator 110 may perform communication with the display apparatus 200 in a short distance wireless communication method such as an RF (Radio Frequency: RF) communication including Bluetooth, Zigbee, and Wi-Fi or Infrared Ray (IP) communication. For this purpose, the communicator 110 may be provided with a communication module that may be used in each of the communication methods.

In response to a predetermined event occurring, the communicator 110 may perform communication with the display apparatus 200 in a pre-defined communication method and be in an interlocked state. Herein, the interlocked state may be a state where communication between the remote control apparatus 100 and display apparatus 200 is initiated, where network is being formed, or where a device pairing is being performed.

For example, in a case of performing communication in a Bluetooth communication method, the communicator 110 may perform pairing with the display apparatus 200 through a Bluetooth communication module, and be in a state where it may communicate with the display apparatus 200.

Furthermore, in a case of having a Zigbee communication module, the communicator 110 may perform pairing with the display apparatus 200 through Zigbee communication module, and be in a state where it may communicate with the display apparatus 200.

Furthermore, the communicator 110 may perform wireless communication with the display apparatus 200 using Wifi and the like. For example, the communicator 110 may be directly connected to the display apparatus 200 without going through a separate network through a Wifi communication module and perform communication or may be connected to the network using an access point and perform communication. As such, the communicator 110 may perform communication with the display apparatus 200 using various communication methods.

Herein, a predetermined event may occur in at least one of the remote control apparatus 100 and display apparatus 200. For example, an event may be a user command of selecting the display apparatus 200 as a subject device for control in the remote control apparatus 100, or an event where the display apparatus 200 is turned on.

The user interface 120 is a configuration for inputting a user command. The user interface 120 may be provided with a plurality of control surfaces in order to receiving input of various user commands for controlling functions of the display apparatus. Accordingly, the user terminal apparatus 100 may be realized to include a touch sensor or an OJ (Optical Joystick) sensor using optic technology.

Herein, the plurality of control surfaces of the user interface 120 may be realized in various formats, but they may have a physically differentiated structure such that a user may recognize a format of manipulation that he/she is inputting by only touching. Especially, the plurality of control surfaces may be configured in an arch structure where the surfaces form a predetermined angle with one another, thereby providing a different touch through a gradient of each control surface. Thus, it is possible to refer that the plurality of control surfaces are differentiated into ridges.

Meanwhile, the user interface 120 may provide a UI screen representing functions allocated on each control surface using a light emitter provided below the plurality of control surfaces. For example, in response to a function allocated on a first control surface being a channel selecting button, the first control surface may display an arrow icon representing channel selecting through the light emitter. Furthermore, in response to a function allocated to a third control surface being a volume adjusting button, the third control surface may display a +/− icon representing volume adjusting through the light emitter.

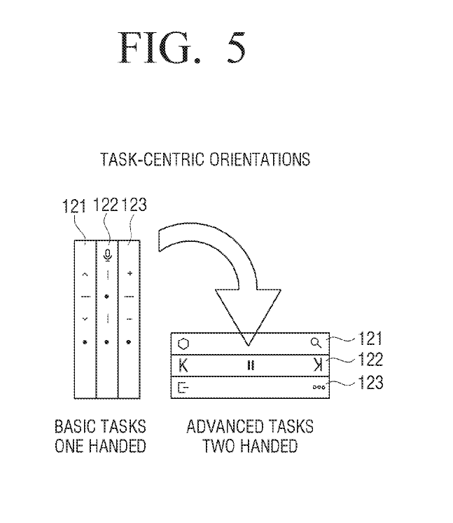

Meanwhile, according to an arrangement state (width mode, length mode) of the remote control apparatus, the UI screen being displayed on the plurality of control surfaces may change. Detailed explanation thereof will be made with reference to FIG. 5 hereinafter.

The processor 130 performs a function of controlling overall operations of the remote control apparatus 100.

Especially, according to a user command being input through at least one of a plurality of control surfaces provided in the user interface 120, the processor 130 may control the communicator 110 to transmit a signal for controlling a display area mapped with a control surface where the user command has been input to the display apparatus.

That is, regarding the plurality of control surfaces, the processor 130 may control each of the display areas separately using mapping information mapped with the display area such that the plurality of display areas are controlled separately. Herein, the plurality of control surfaces may have a layout that matches with a plurality of display areas, and the user may control each display area by intuitive manipulation. For example, the screen being displayed in the display apparatus may be divided into a first area, second area and third area sequentially, and accordingly, the remote control apparatus 100 is provided with a first control surface, second control surface and third control surface from the left side to have a layout that matches with the first to third areas.

In such a case, the first area may be controlled by the first control surface, the second area may be controlled by the second control surface, and the third area may be controlled by the third control surface.

Herein, the processor 130 may transmit a signal for controlling a UI screen displayed on an display area mapped with a control surface where a user command has been input of among a plurality of UIs (User Interfaces) provided in each of the plurality of display areas.

The user may control the UI screen provided in each display area through the remote control apparatus 100. For example, the user may control a channel selecting UI displayed on the first area of the display screen to change a channel by touching an arrow icon displaying a channel selecting function allocated on the first control surface.

Meanwhile, the remote control apparatus 100 may further include a mode state detector configured to determine an arrangement state of the remote control apparatus 100 and to detect a length mode state or width mode state according to the determined arrangement state, and the processor 130 may control a UI screen corresponding to the detected mode state to be displayed on each of the plurality of control surfaces.

That is, the user may divide the remote control apparatus 100 by a length and width according to attributes of the UI screen being displayed. For example, in a case of merely selecting a channel or adjusting volume, it is convenient to divide the remote control apparatus 100 by length and manipulate the same, but in a case of selecting a replay section or inputting a letter while watching a movie, it is convenient to divide the remote control apparatus 100 by width and manipulate the same.

Accordingly, the processor 130 detects whether the arrangement state of the remote control apparatus 100 is a length mode state or a width mode state, and allocates a function corresponding to the detected mode state to the plurality of control surfaces. For example, in response to the arrangement state of the remote control apparatus 100 being a length mode state, a channel selecting function is allocated to the first control surface, but in response to the arrangement state of the remote control apparatus 100 being a width mode state, a replay section selecting function may be allocated. At the same time, the processor 130 may control a light emitter such that a UI screen corresponding to the detected mode state is displayed on each of the plurality of control surfaces.

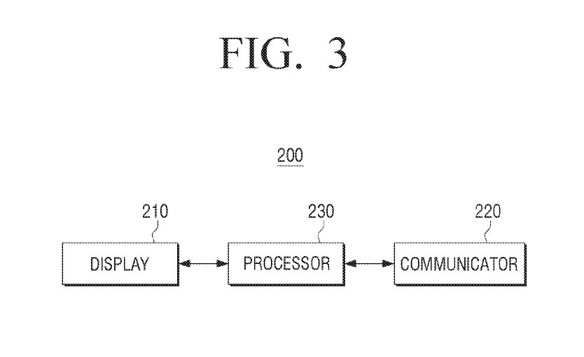

FIG. 3 is a block diagram schematically illustrating a configuration of a display apparatus according to an embodiment of the present disclosure.

The display apparatus 200 is a configuration for displaying a content being received through an image signal such as a TV signal. The display apparatus 200 may output an image and sound to outside at the same time and provide various types of audiovisual contents to the user.

The display apparatus 200 may be provided with infrared receiving means configured to receive infrared ray emitted from the remote control apparatus 100 by an IR communication method or transmission means configured to receive a predetermined control command by an RF communication method from the remote control apparatus 100, for example an RF communication module.

The display apparatus 200 may be any type of display apparatus that may be controlled by the remote control apparatus 100. For example, the display apparatus 200 may be any type of display apparatus that may display images through a screen such as a TV including smart TVs and computer and the like.

According to FIG. 3, the display apparatus 200 according to an embodiment of the present disclosure includes a display 210, communicator 220, and a controller or processor 230.

The display 210 is a configuration for providing a content screen. Especially, the display 210 may divide the screen being displayed into a plurality of display areas, and provide each of a plurality of UI screens in each of the display areas. The display 210 may display an environment setting menu, information on adjusting a channel and volume, and various contents information and the like, and the contents being displayed may include an image and text that represent the contents. The display 210 may be set to display only some of the plurality of UI screens.

The plurality of display areas may be divided in various ways. For example, the display areas may be divided into three areas in a length or width direction, or into two areas or in four or more areas. Such a dividing method may be predetermined according to a layout of a plurality of control surfaces mapped to each of the display areas.

The display 210 may be realized as an LCD (Liquid Crystal Display Panel) or OLED (Organic Light Emitting Diodes), but there is no limitation thereto. Furthermore, the display 210 may be realized as a flexible display, or transparent display and the like in some cases.

The communicator 220 is a configuration for performing communication with the remote control apparatus 100. The communicator 220 may communicate with the display apparatus 100 according to a short distance wireless communication method such as an RF communication or infrared (IR) communication including Bluetooth, Zigbee, and Wi-Fi and the like. For this purpose, the communicator 220 may be provided with a communication module that may be used in each communication method.

The display apparatus 200 is provided with a communication module for performing communication in the same manner as the communicator 110 of the remote control apparatus 100. The method for performing communication with the display apparatus 200 was explained with reference to FIG. 2, and thus repeated explanation will be omitted.

The processor 230 is a configuration for controlling overall operations of the display apparatus 200.

Especially, in response to receiving a control signal corresponding to a user command input through at least one of a plurality of control surfaces provided in the remote control apparatus 100, the processor 230 may control a display area corresponding to the received control signal of among the plurality of display areas. Herein, as aforementioned, each of the plurality of display areas provided in the screen is mapped with a plurality of control surfaces provided in the remote control apparatus 100.

Furthermore, the processor 230 may control a UI screen corresponding to a control signal received from the remote control apparatus 100 of among a plurality of UI screens provided in each of a plurality of display areas, and may divide the screen in a plurality of display areas in a length or width direction based on attributes of the UI screen to be displayed on the screen and provide a UI screen.

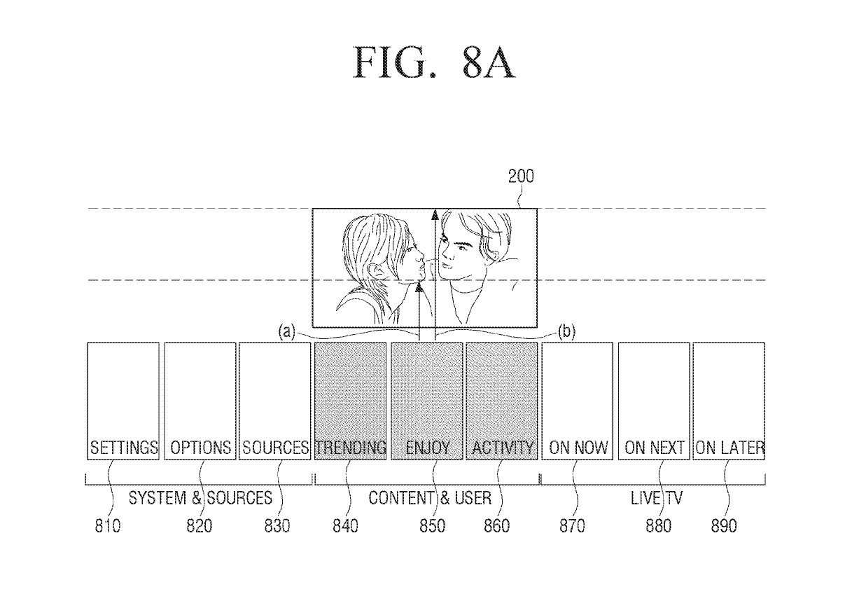

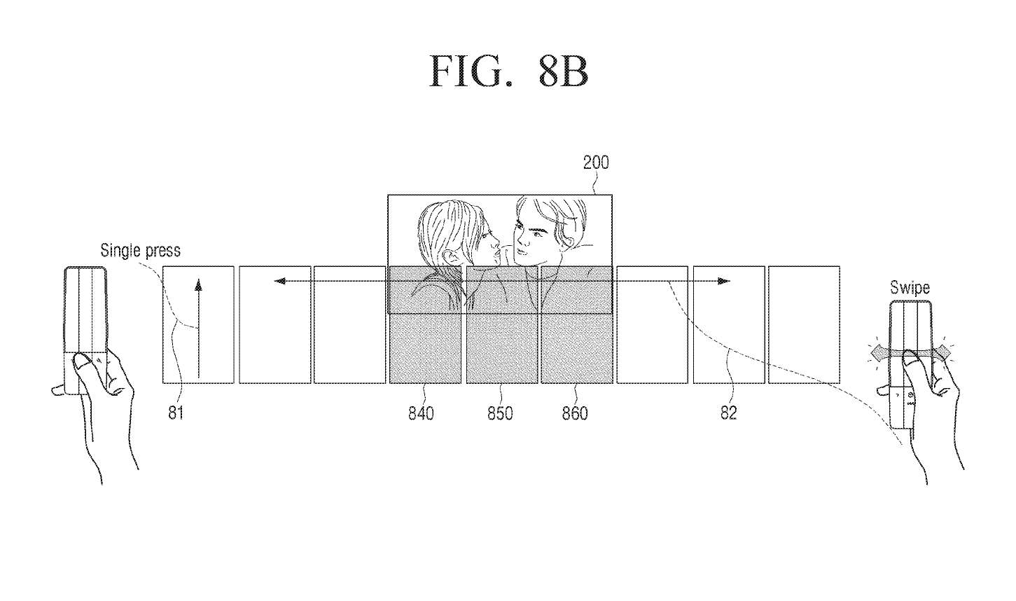

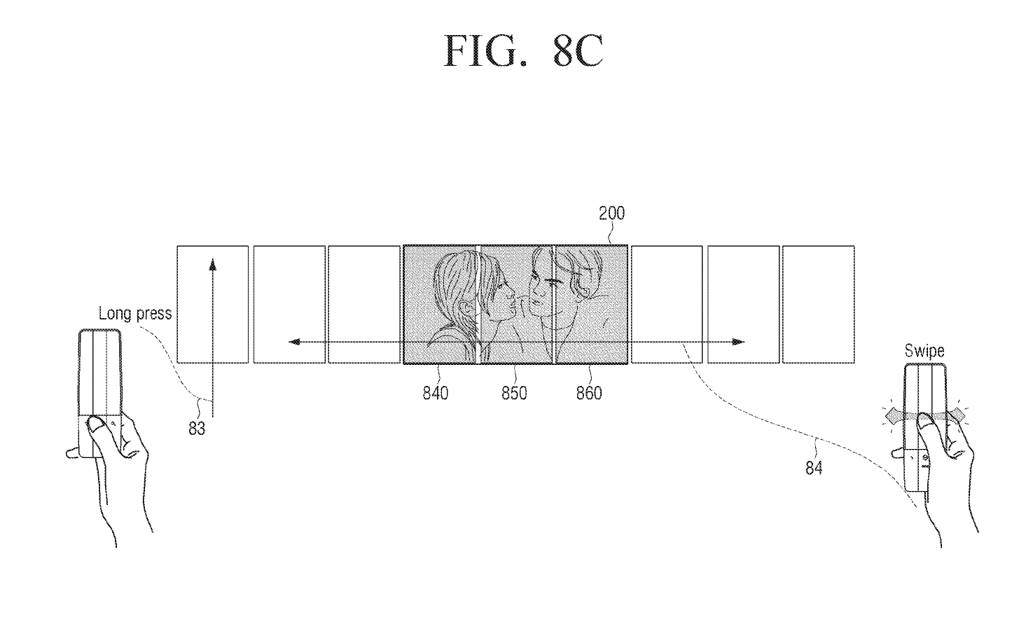

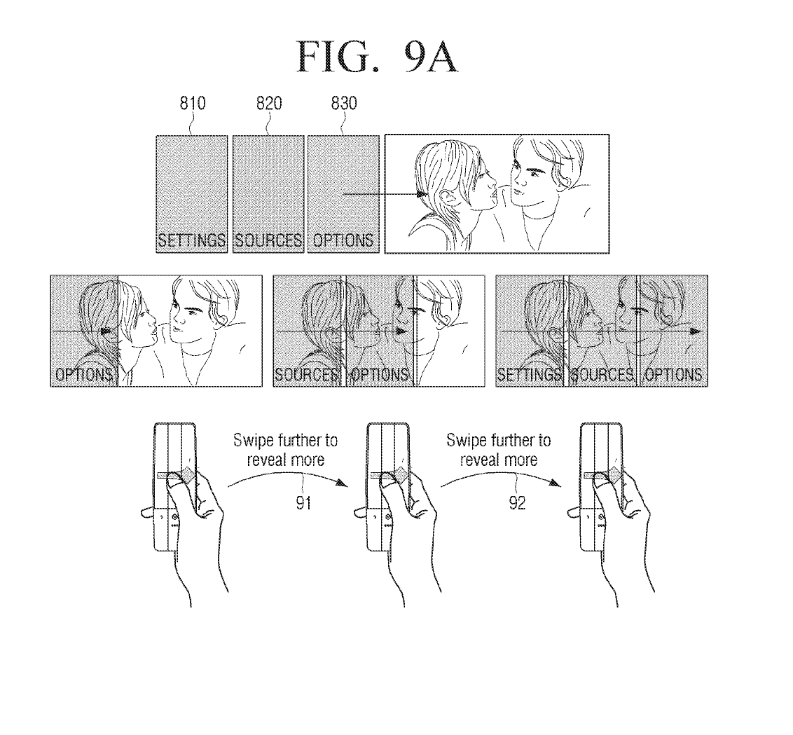

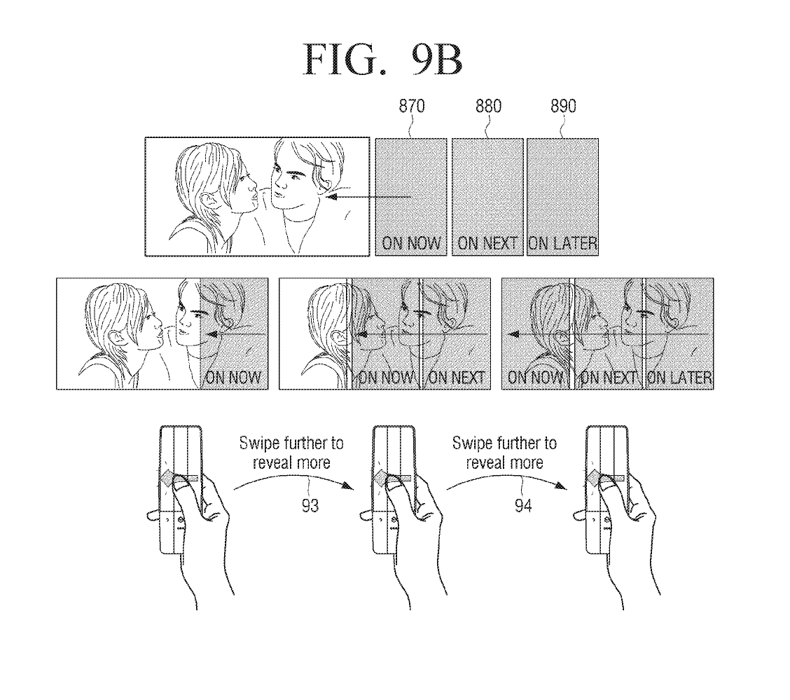

Furthermore, in response to receiving a control signal according to a touch input of crossing the plurality of control surfaces from the remote control apparatus 100, the processor 230 may control the plurality of display areas such that a different UI screen is sequentially displayed thereon, and in response to receiving a control signal according to a press input from the remote control apparatus 100, the processor 230 may control such that at least a portion of a different UI screen is displayed in each of a plurality of display areas at the same time based on the press input method. Specific explanation thereof will be made hereinafter with reference to FIGS. 8a to 9c.

FIG. 4 is a view for explaining mapping a plurality of controls surfaces and display areas according to an embodiment of the present disclosure.

As illustrated in (a) of FIG. 4, the first control surface 121 of the remote control apparatus 100 is mapped with the first area 10 of among the plurality of display areas of the screen being provided in the display apparatus 200. Accordingly, in response to a user command being input using the first control surface 121, a signal for controlling the first area 10 mapped with the first control surface 121 may be transmitted to the display apparatus 200. In such a case, a signal for controlling a UI screen provided in the first area 10 of among the plurality of display areas 10˜30 may be transmitted to the display apparatus 200.

Meanwhile, as illustrated in (b) of FIG. 4, the second control surface 122 of the remote control apparatus 100 is mapped with the second area 20 of among the plurality of display areas of the screen provided in the display apparatus 200. Accordingly, in response to a user command being input using the second control surface 122, a signal for controlling the second area 20 mapped with the second control surface 122 may be transmitted to the display apparatus 200. In such a case, a signal for controlling a UI screen being provided in the second area 20 of among the plurality of display areas 10˜30 may be transmitted to the display apparatus 200.

Meanwhile, as illustrated in (c) of FIG. 4, the third control surface 123 of the remote control apparatus 100 is mapped with the third area 30 of among the plurality of display areas of the screen being provided in the display apparatus 200. Accordingly, in response to a user command being input using the third control surface 123, a signal for controlling the third area 30 mapped with the third control surface 123 may be transmitted to the display apparatus 200. In such a case, a signal for controlling a UI screen provided in the third area 30 of among the plurality of display areas 10˜30 may be transmitted to the display apparatus 200.

FIG. 5 is a view for explaining changing a function according to an arrangement state of the remote control apparatus according to an embodiment of the present disclosure.

According to FIG. 5, the remote control apparatus 100 may perform different functions according to a length mode or width mode. More specifically, the remote control apparatus 100 may further include a mode state detector configured to detect a length mode or width mode state according to the determined arrangement state. Herein, the mode state detector may determine the arrangement state of the remote control apparatus 100 by sensing at least one of a rotation and gradient through at least one of a gyro sensor and acceleration sensor provided in the user terminal apparatus 100.

In a case where it is easier to divide the remote control apparatus 100 and manipulate the same with one hand, the remote control apparatus being in a length mode may be easier to the user. Meanwhile, in a case where it is easier to divide and manipulate the remote control apparatus 100 with two hands, the remote control apparatus 100 being in a width mode may be easier to the user.

For example, in the case of a simple manipulation such as adjusting volume, selecting a channel or searching a channel while watching TV, it may be easier to divide the remote control apparatus 100 and manipulate the remote with one hand, and accordingly, in each of the plurality of control surfaces 121˜123 of the remote control apparatus 100, a predetermined function (adjusting volume and selecting channel and the like) according to a length mode may be allocated.

Meanwhile, in a case where it is necessary to perform a manipulation of selecting a replay section through swiping while watching a movie, it may be easier to divide and manipulate the remote control apparatus 100 with two hands, and accordingly, in each of the plurality of control surfaces 121˜123 of the remote control apparatus 100, a predetermined function (stop, selecting a previous media and next media, selecting replay section and the like) according to a width mode may be allocated.

Herein, as illustrated in FIG. 5, the remote control apparatus 100 may display a UI screen corresponding to the detected mode state in each of the plurality of control surfaces 121˜123 using the light emitter provided inside the plurality of control surfaces 121˜123.

In such a case, the display apparatus 200 may divide the screen into a plurality of display areas in a length direction or width direction based on attributes of a UI screen to be displayed on the screen, and provide the UI screen. Detailed explanation thereof will be made with reference to FIG. 6 hereinafter.

FIG. 6 is a view for explaining mapping the plurality of control surfaces and display areas according to another embodiment of the present disclosure.

The display apparatus 200 may divide the plurality of display areas based on attributes of the UI screen to be displayed on the screen. For example, in a case where a movie is currently being replayed in the display apparatus 200, the UI screen to be displayed on the screen may be a UI screen for selecting a replay section, adjusting volume, selecting a previous media or selecting a next media and the like.

Herein, since it is easier to display a UI on a display area divided in a width direction, the display apparatus 200 may divide the plurality of display areas in a width direction and provide a UI screen. Such a method of dividing a plurality of display areas according to the attributes of the UI screen to be displayed may be predetermined.

As illustrated in (a) of FIG. 6, in a case of dividing the plurality of display areas being provided in the display apparatus 200 in a width direction, a first control surface 121 of the remote control apparatus 100 is mapped with a fourth area 40 of among the plurality of display areas of the screen being provided in the display apparatus 200. Accordingly, in response to a user command being input using the first control surface 121, a signal for controlling the fourth area 40 mapped with the first control surface 121 may be transmitted to the display apparatus 200. In such a case, a signal for controlling a UI screen provided in the fourth area 40 of among the plurality of display areas 40˜60 may be transmitted to the display apparatus 200.

Meanwhile, as illustrated in (b) of FIG. 6, the second control surface 122 of the remote control apparatus 100 is mapped with a fifth area 50 of among a plurality of display areas of the screen being provided in the display apparatus 200. Accordingly, in response to a user command being input using the second control surface 122, a signal for controlling the fifth area 50 mapped with the second control surface 122 may be transmitted to the display apparatus 200. In such a case, a signal for controlling the UI screen provided in the fifth area 50 of among the plurality of display areas 40˜60 may be transmitted to the display apparatus 200.

Meanwhile, as illustrated in (c) of FIG. 6, the third control surface 123 of the remote control apparatus 100 is mapped with a sixth area of among the plurality of display areas of the screen being provided in the display apparatus 200. Accordingly, in response to a user command being input using the third control surface 123, a signal for controlling the sixth area 60 mapped with the third control surface may be transmitted to the display apparatus 200. In such a case, a signal for controlling the UI screen being provided in the sixth area 60 of among the plurality of display areas 40˜60 may be transmitted to the display apparatus 200.

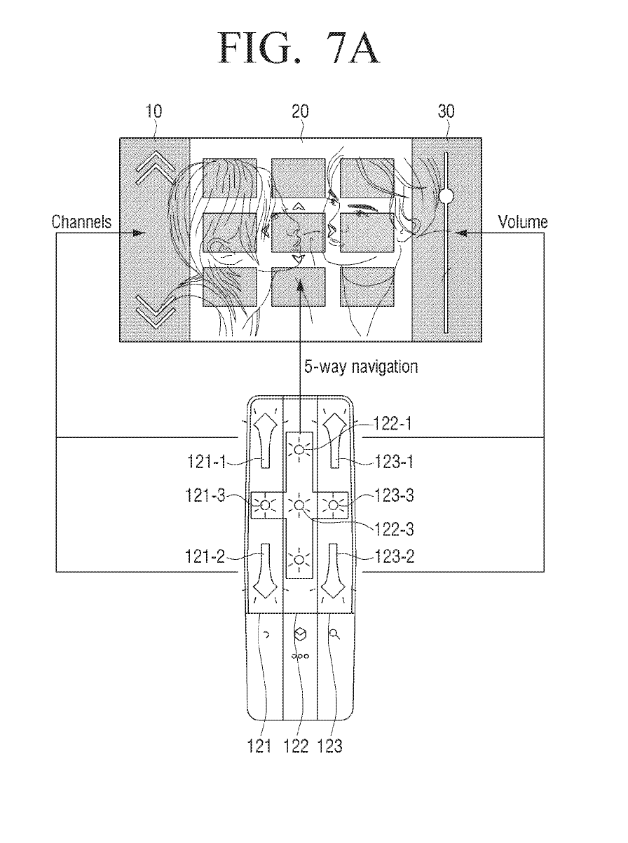

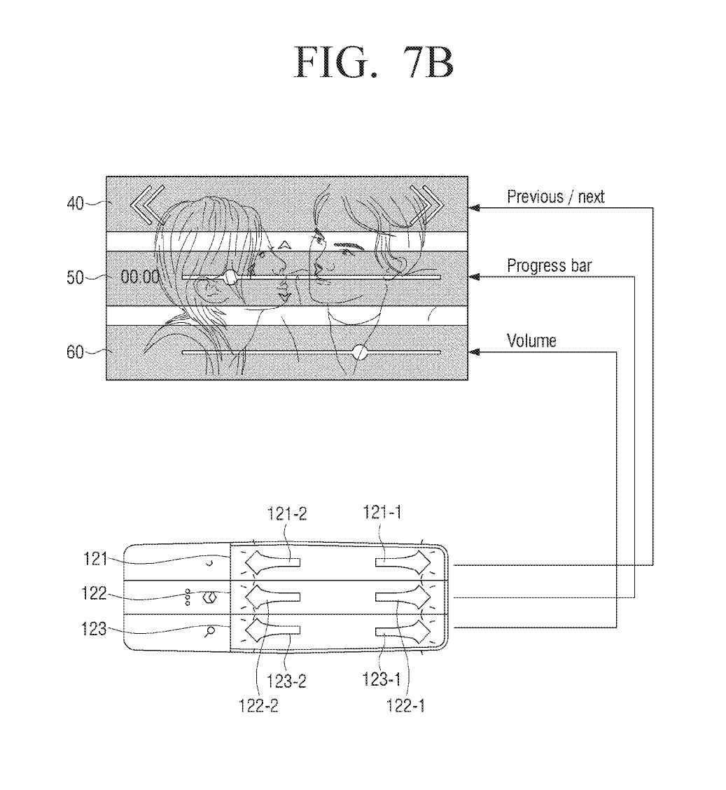

FIGS. 7a and 7b are views for explaining in detail mapping of the plurality of control surfaces and display areas according to an embodiment of the present disclosure.

As illustrated in FIG. 7a, in a case where the plurality of display areas being provided on the screen of the display apparatus 200 are divided in a length direction, on each control surface 121˜123 of the remote control apparatus 100, a function corresponding to a length mode state may be allocated.

More specifically, on the first control surface 121 of the remote control apparatus 100, a channel selecting function 121-1 and 121-2 may be allocated, and on the third control surface 123, a volume adjusting function 123-1, 123-2 may be allocated. Meanwhile, on the first to third control surfaces of the remote control apparatus 100, navigation keys 121-3, 122-1, 122-2, 122-3, 123-3 of five directions may be allocated.

Accordingly, by manipulating the first control surface 121, it is possible to control a channel selecting UI screen being provided in the first area 10 of among the plurality of display areas, and by manipulating the third control surface 123, it is possible to control a volume adjusting UI screen being provided in the third area 30. Furthermore, by manipulating the navigation keys 121-3, 122-1, 122-2, 122-3, 123-3 provided in the first control surface to third control surface 121˜123 and controlling various function selecting UIs provided in the second area 20, it is possible to perform a desired function.

Meanwhile, as illustrated in FIG. 7b, in a case where the plurality of display areas provided on the screen of the display apparatus 200 are divided in a width direction, on each control surface 121˜123 of the remote control apparatus 100, a function corresponding to a width mode state may be allocated.

More specifically, on the first control surface 121 of the remote control apparatus 100, a previous media selecting and next media selecting function 121-1, 121-2 may be allocated, and on the second control surface 122, a replay section selecting function 122-1, 122-2 may be allocated. Furthermore, on the third control surface 123, a volume adjusting function 123-1, 123-2 may be allocated.

Accordingly, it is possible to manipulate the first control surface 121 and control a media selecting UI screen being provided in the fourth area 40 of among the plurality of display areas, and it is possible to manipulate the third control surface 123 and control a volume adjusting UI screen being provided in the sixth area 60.

FIGS. 8a to 12 are views for explaining a method for providing a UI screen in a plurality of display areas according to various embodiments of the present disclosure.

FIG. 8a illustrates a method for providing various UI screens in each of the plurality of display areas of the screen of the display apparatus according to an embodiment of the present disclosure.

As illustrated in FIG. 8a, various UI screens may be configured as a live TV UI that includes a system & source UI including a setting menu UI 810, option menu UI 820, and source menu UI 830; a UI 840 for displaying contents regarding a trend; a UI 850 including contents regarding fun; contents & user UI including a UI 860 for displaying contents regarding activities; a UI 870 for displaying information on TV programs currently being aired; UI 880 for displaying TV programs to be aired next after a TV program currently being aired ends; and a UI 890 for displaying information on TV programs to be aired subsequently.

According to a press input, the remote control apparatus 100 may provide a UI screen to each of the plurality of display areas. Herein, a portion of the UI screen may be displayed on each of the display areas at the same time while covering a portion of the screen currently being displayed (a). Meanwhile, a portion of the UI screen may be displayed on each of the display areas at the same time while covering an entirety of the screen currently being displayed (b).

With reference to FIG. 8b, in a case where the user for example performs a short single press 81 on a key pad provided in the remote control apparatus 100, as illustrated, a portion of the UI screen 840, 850, 860 may appear in each of the display areas at the same time while covering a portion of the screen currently being displayed.

Herein, the user may control the display apparatus to display different UI screens sequentially on each of the plurality of display areas by performing a touch input of cross swiping 82 the plurality of control surfaces provided in the remote control apparatus 100. In such a case, each UI screen may be changed individually and displayed, and may be changed per group and displayed.

With reference to FIG. 8c, in a case where the user performs a long press 83 on a key pad provided in the remote control apparatus 100, as illustrated, an entirety of the UI screens 840, 850, 860 may appear in each display area at the same time while overlapping the screen currently being displayed.

Herein, the user may control the display apparatus to display different UI screens sequentially in each of the plurality of display areas by performing a touch input of cross swiping 84 the plurality of control surfaces provided in the remote control apparatus 100. In such a case as well, each UI screen may be changed individually and displayed, and may be changed per group and displayed.

Meanwhile, according to FIG. 9a, it is possible to display different UI screens in each of the plurality of display areas sequentially by performing a touch input of crossing the control surfaces provided in the remote control apparatus 100.

For example, in a case of performing a cross swiping in a right direction once, the option menu UI 830 may be displayed in one display area in a cross swiping direction, and in a case of performing a cross swiping in a right direction one more time 91, a source menu UI 820 may be displayed additionally. Herein, in a case of performing a cross swiping in a right direction one more time 92, a setting menu UI 810 may be displayed, thereby displaying the UI screen on an entirety of the screen.

Meanwhile, according to FIG. 9b, it is possible to display different UI screens in each of the plurality of display areas in different methods by performing a touch input of crossing the control surface provided in the remote control apparatus 100 in an opposite direction.

For example, in a case of performing a cross swiping in a left direction once, the UI 870 displaying information on TV programs currently being aired may be displayed in one display area in a cross swiping direction, and in a case of performing a cross swiping in a left direction one more time 93, a UI 880 display information on next TV programs to be aired after the TV programs currently being aired ended may be displayed additionally. Herein, in a case where a cross swiping is performed in a left direction one more time 94, a UI 890 displaying information on TV programs to be aired subsequently may be displayed, thereby displaying the UI screen on the entirety of the screen.

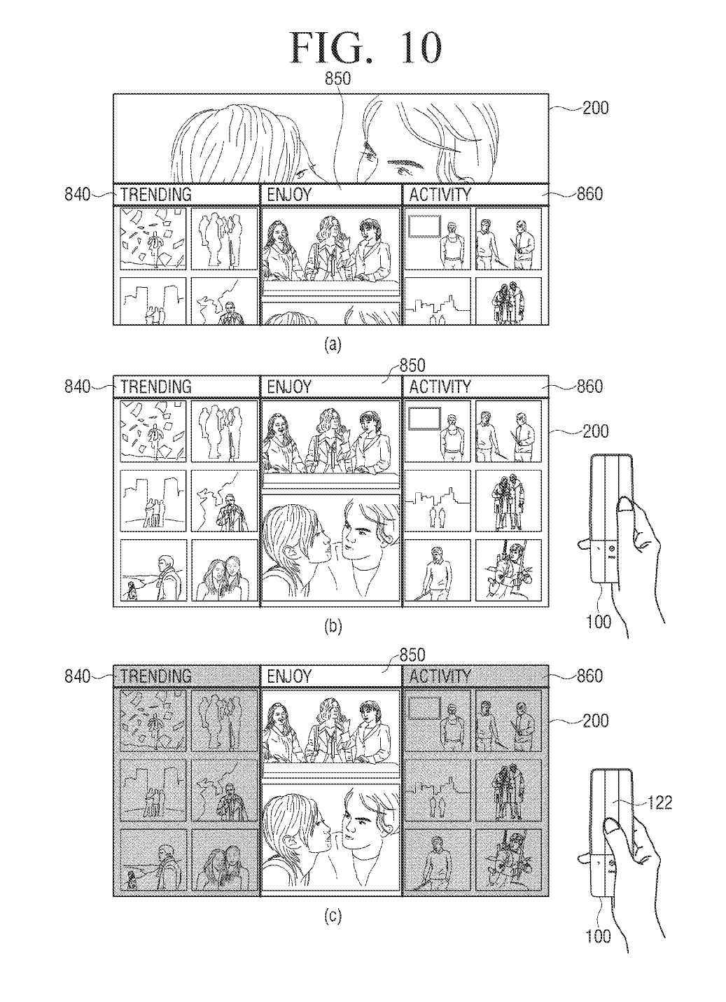

FIG. 10 illustrates a method for selecting and controlling a UI screen provided in a plurality of display areas.

As illustrated in (a) of FIG. 10, a UI group screen consisting of a plurality of UI screens 840, 850, 860 may be partially displayed based on a press input method of the remote control apparatus 100, or as illustrated in (b) of FIG. 10, an entirety of the UI screens may be displayed.

In such a case, in a case where the user intends to select a UI 850 displaying contents of fun, the UI 850 displayed in the second area may be selected and controlled through controlling of for example clicking the second control surface 122 mapped to the second area where the corresponding UI is being displayed.

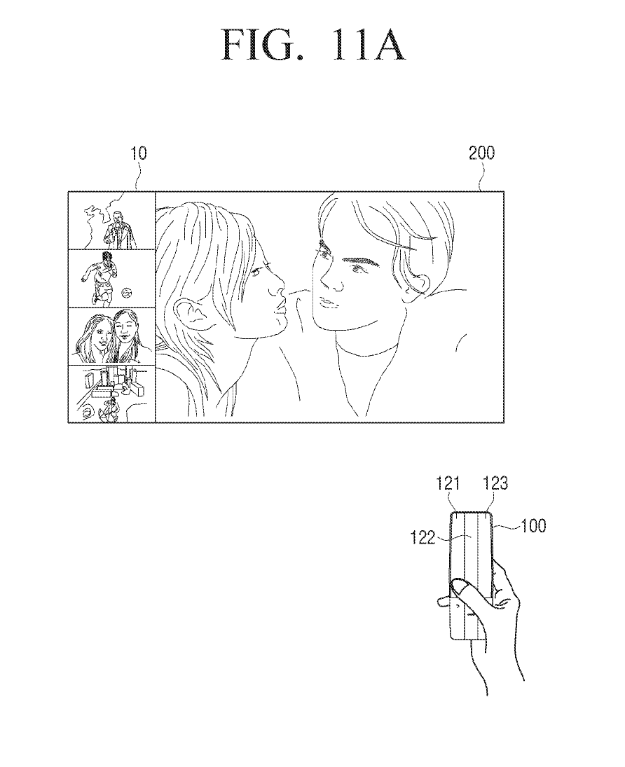

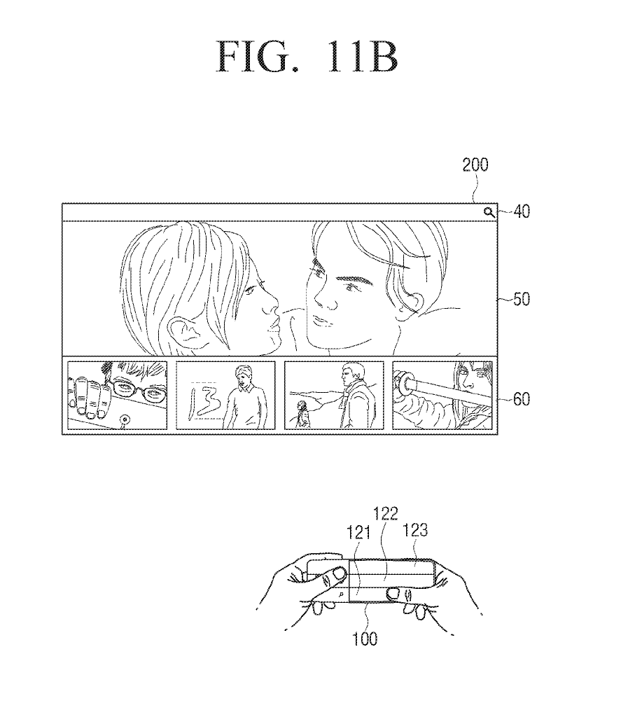

FIG. 11a illustrates an embodiment where a plurality of display areas provided on the screen of the display apparatus 200 are divided in various sizes and methods.

As illustrated in FIG. 11a, the first area 10 that is a display area mapped to the first control surface 121 of the remote control apparatus 100 may provide contents related to the contents currently being displayed in thumbnail images of small sizes so as not to interrupt viewing of the user. In such a case, by controlling the first control surface 121, the user may perform a manipulation of selecting one of various contents on the UI screen being provided in the first area 10.

Meanwhile, as illustrated in FIG. 11b, the fourth area 40 mapped to the first control surface 121 of the remote control apparatus 100 and the sixth area 60 that is a display area mapped to the third control surface 123 may also be displayed in small sizes so as not to interrupt viewing of the user. FIG. 11b illustrates an embodiment where the fourth area 4 provides an input window, and the sixth area 60 provides contents related to the contents being displayed on the second area 50 in thumbnail images. Accordingly, by controlling the first control surface 121, the user may select a search input window being provided in the fourth area 40, and by controlling the third control surface 123, the user may perform a manipulation of selecting one of the various contents of the UI screen being provided in the sixth area 60.

Meanwhile, as illustrated in (a) of FIG. 12, the first area 40 of the plurality of display areas of the screen provided in the display apparatus 200 may provide a UI screen from which an upper menu such as a content type may be selected, and the third area 60 may provide a UI screen from which a lower menu regarding the content type selected in the first area 30 may be selected. Meanwhile, the second area 50 may display content according to the menu selected in the first area 40 and third area 60.

Accordingly, as illustrated in (b) of FIG. 12, the user may control the UI screen being provided in the display area mapped through each control surface 121˜123 of the remote control apparatus 100 mapped to each display area.

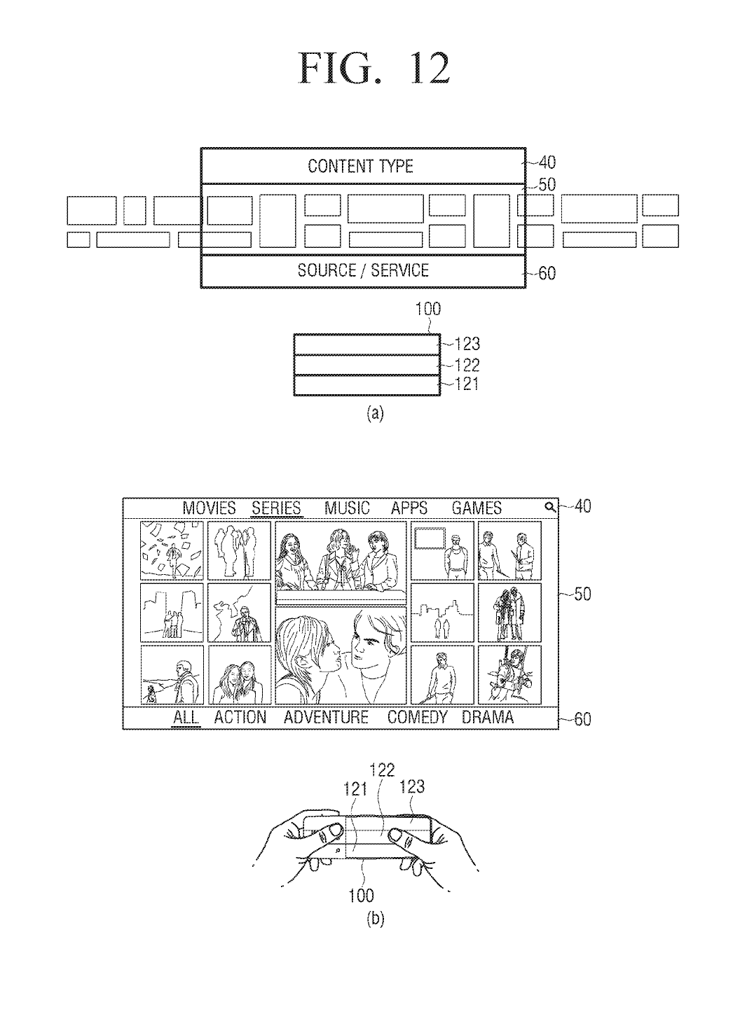

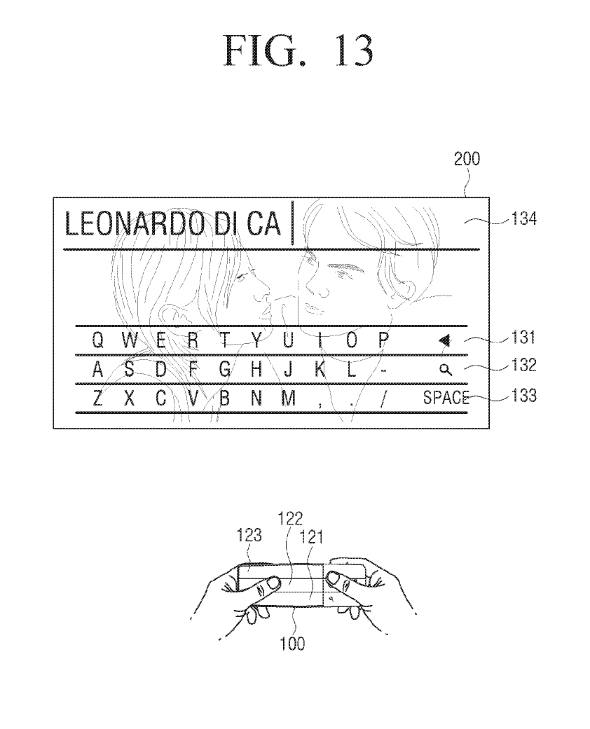

FIG. 13 is a view for explaining a method for inputting a letter using a remote control apparatus according to an embodiment of the present disclosure.

As illustrated in FIG. 13, a letter input window of a qwerty keyboard arrangement from which a letter may be selected may be displayed on the screen of the display apparatus 200. In such a case, in the remote control apparatus 100, a function according to a width mode may be mapped with each control surface 121˜123. More specifically, on the first control surface 121, second control surface 122 and third control surface 123 of the remote control apparatus 100, at least a top end key 131, intermediate end key 132, and bottom end key 133 of the qwerty keyboard arrangement provided on the screen of the display apparatus 200 may be mapped respectively. For example, the user may select a letter in the top key 131 by swiping the first control surface 121, and select a letter on the stop key 132 by swiping the second control surface 122. Furthermore, the user may select a letter in the bottom key 133 by swiping the third control surface 123. The selected letter may be displayed on an area 134 of the display screen. Accordingly, the user may perform the operation of inputting a letter more intuitively.

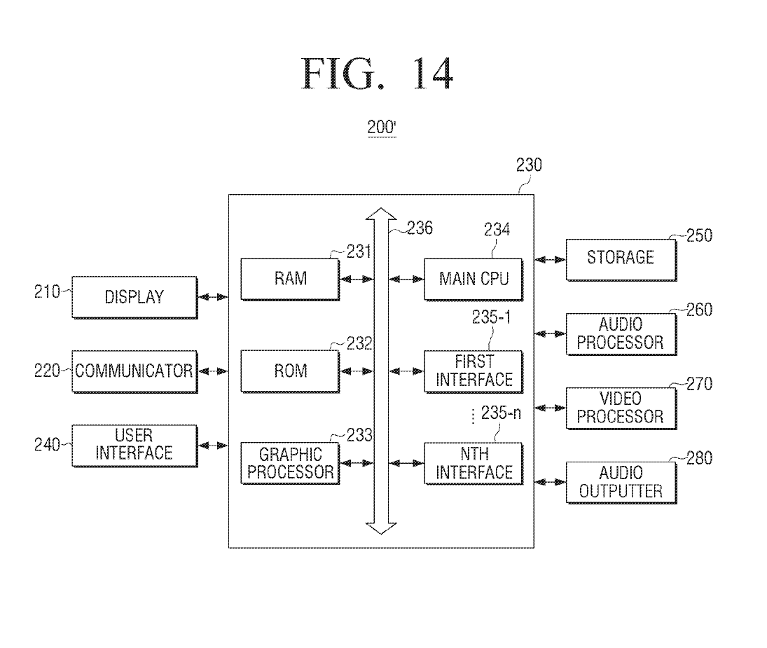

FIG. 14 is a block diagram illustrating in detail a configuration of a display apparatus according to another embodiment of the present disclosure.

As illustrated in FIG. 14, the display apparatus 200′ according to another embodiment of the present disclosure includes a display 210, communicator 220, a controller or processor 230, user interface 240, storage 250, audio processor 260, video processor 270, and audio outputter 280. Hereinafter, explanation on components overlapping the explanation already made with reference to FIG. 3 will be omitted.

The user interface 240 is a component for sensing user interaction for controlling overall operations of the display apparatus 200′. Especially, the user interface 200′ may include various interaction sensors such as a camera (not illustrated), microphone (not illustrated), and remote signal receiver (not illustrated) and the like.

The storage 250 is a component for storing various modules for driving the display apparatus 200′.

More specifically, the storage 250 may store a base module for processing signals transmitted from hardware included in the display apparatus 200′, a storage module for managing a database (DB) or registry, security module, and communication module and the like. Especially, the storage 250 may store a module configured to divide the display screen into a plurality of display areas and to control each display area separately.

The audio processor 260 is a component for processing audio data.

The video processor 270 is a component for processing various images such as decoding input images, scaling, noise filtering, converting frame rates and converting resolution and the like.

The audio outputter 280 is a component for outputting audio.

The processor 230 may control overall operations of the display apparatus 200 using various modules stored in the storage 250.

As illustrated in FIG. 14, in the processor 230, the RAM 231, ROM 232, graphic processor 233, main CPU 234, and first to nth interfaces 235-1˜235-n may be connected to one another through a bus 236.

In the ROM 232, a set of commands for booting the system is stored. The main CPU 234 copies various application programs stored in the storage 250 in the RAM 231, and executes application programs copied in the RAM 231 to perform various operations.

The graphic processor 233 generates a screen that includes various objects such as an icon, image, and text and the like using the operator (not illustrated) and renderer (not illustrated). The operator computes an attribute value such as a coordinate value, shape, size, and color and the like of each object to be displayed according to the layout of the screen. The renderer generates a screen of various layouts including the object based on the attribute value computed in the operator.

The main CPU 234 accesses the storage 250, and performs booting using the 0/S stored in the storage 250. Furthermore, the main CPU 234 performs various operations using various programs, contents, data and the like stored in the storage 250.

The first to nth interfaces 235-1 to 235-n are connected to various components aforementioned. One of the interfaces may be a network interface that may be connected to an external apparatus through the network.

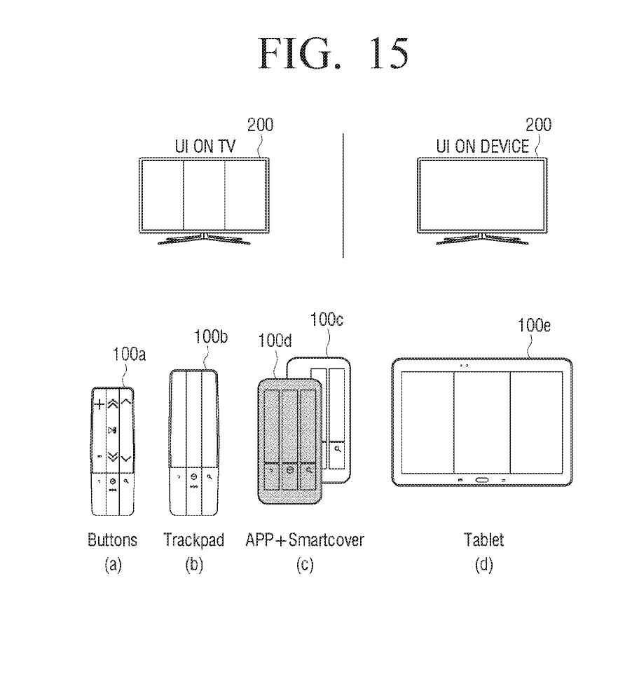

FIG. 15 is a view illustrating a remote control apparatus or device realized in various methods according to various embodiments of the present disclosure.

As illustrated in (a) of FIG. 15, the remote control apparatus may be a remote control apparatus 100a consisting of only a button type key pad. Otherwise, the remote control apparatus 100a may consist of only a track pad that is capable of sensing movement of a finger, or it may be configured as a remote control apparatus 100b where a track pad and a button type key pad are combined.

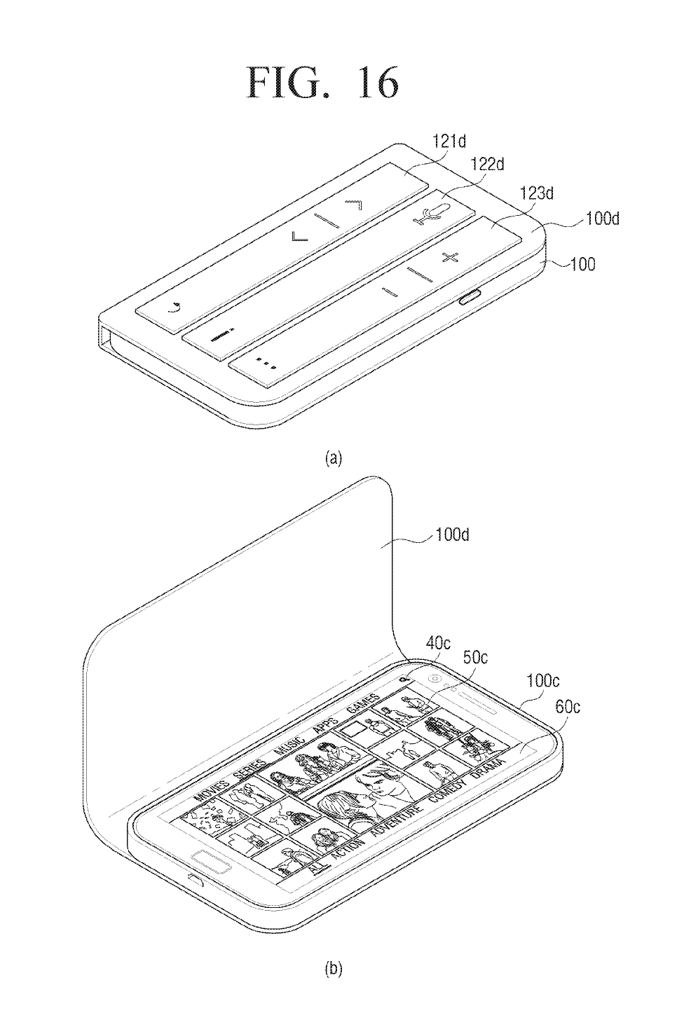

Meanwhile, as illustrated in (c) of FIG. 15, in a case where the remote control apparatus is realized as a case cover 100d that is separable from the smart phone 100c and is combined with the smart phone 100c, the smart phone 100c may be realized to provide a same function as the remote control apparatus, for example, a remote control function. More specific explanation thereof will be made with reference to FIG. 16.

Meanwhile, as illustrated in (d) of FIG. 15, the remote control apparatus may be realized as an application inside a portable display apparatus such as a tablet PC 100e and be driven. In such a case, each of the divided area of the touch screen of the tablet PC 100e may serve the function of the plurality of control surfaces of the present disclosure.

FIG. 16 is a view illustrating a user terminal apparatus and remote control apparatus realized as a cover according to an embodiment of the present disclosure.

According to FIG. 16, a plurality of control surfaces 121d˜123d may be provided in the case cover 100d that is combined with the smart phone 100′. For this purpose, on the bottom part of the plurality of control surfaces, a strip sensor or flex sensor for sensing a touch input or press input and a light emitter (not illustrated) for emitting light to an item may be included.

With the smart phone 100′ executing an application for realizing a remote control function, it becomes possible to control the plurality of display areas on the screen of the display apparatus by inputting a user command through the case cover 100d.

Meanwhile, in a case of opening the case cover 100d, the smart phone 100′ may mirror a same screen as the screen of the display apparatus and display the same. Accordingly, the user may control the display apparatus easily using a portable display apparatus such as the smart phone 100′ and the like.

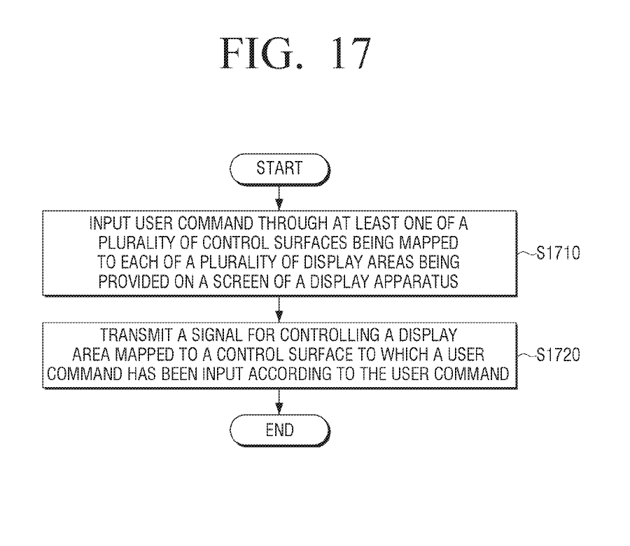

FIG. 17 is a flowchart for explaining a method for controlling the remote control apparatus according to an embodiment of the present disclosure.

First of all, a user command is received through at least one of the plurality of control surfaces each mapped to the plurality of display areas provided on the screen of the display apparatus (S1710). Herein, the plurality of control surfaces may have a physically divided structure.

Then, a signal for controlling a display area mapped to a control surface to which the user command has been input is transmitted to the display apparatus (S1720). Herein, it is possible to transmit a signal for controlling a UI screen displayed on the display area mapped to the control surface to which the user command has been input of among the UI screens provided in each of the plurality of display areas. Furthermore, it is possible to determine an arrangement state of the remote control apparatus, detect a length mode state or width mode state according to the determined arrangement state, and control a UI screen corresponding to the detected mode state to be displayed on each of the plurality of control surfaces.

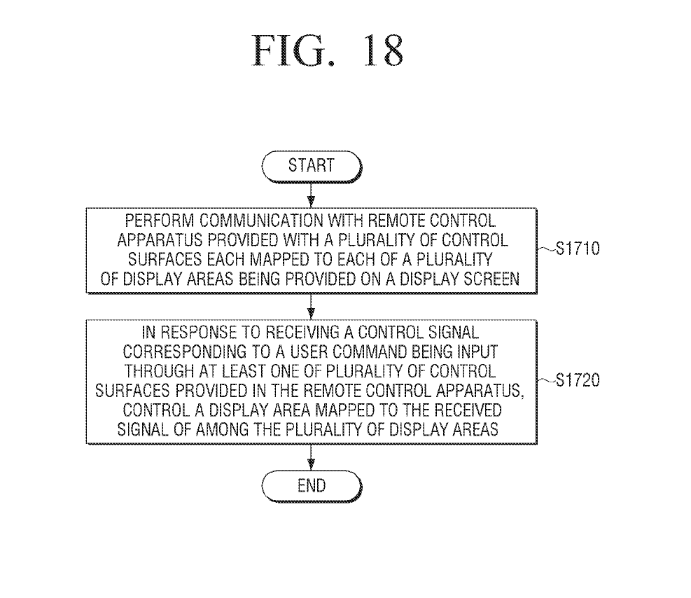

FIG. 18 is a flowchart for explaining a method for controlling a display apparatus according to an embodiment of the present disclosure.

First of all, communication is performed with the remote control apparatus having the plurality of control surfaces mapped to each of the display areas provided on the display screen (S1810).

Herein, when a control signal is received that corresponds to a user command being input through at least one the plurality of control surfaces provided in the remote control apparatus, the display area corresponding to the received control signal of among the plurality of display areas is controlled (S1820). Herein, it is possible to control a UI screen corresponding to the control signal received from the remote control apparatus of among the plurality of UI screens each provided on the plurality of display areas. Furthermore, it is possible to divide the screen into a plurality of display areas in a length direction or width direction based on attributes of the UI screen to be displayed on the screen and provide the UI screen.

According to the aforementioned embodiments of the present disclosure, it is possible to provide physically intuitive manipulating experience regarding the UI being provided on the display screen, thereby improving user convenience.

A remote control apparatus and a method for controlling a display apparatus according to the aforementioned various embodiments may be realized as a program and stored in various types of record media. That is, a computer program that is processed by various types of processors and that is capable of executing the aforementioned various control methods may be stored in a record media and be used.

For example, there may be provided a non-transitory computer readable medium that includes a step of performing communication with a remote control apparatus having a plurality of control surfaces each mapped to each of a plurality of display areas, and a step of, in response to receiving a control signal corresponding to a user command being input through at least one of the plurality of control surfaces provided in the remote control apparatus, controlling a display area mapped to a control surface to which the user command has been input of among the plurality of display areas according to the user command.

A non-transitory computer readable medium is a medium that can be read by a computer and that is capable of storing data semi-permanently and not a medium that stores data for a short period of time such as a register, cache and memory and the like. More specifically, the aforementioned various applications or programs may be stored in a non-transitory computer readable medium such as a CD, DVD, hard disc, Blue-ray disc, USB, memory card, or ROM and the like, and be provided.

The foregoing exemplary embodiments and advantages are merely exemplary and are not to be construed as limiting the embodiments. The present teaching can be readily applied to other types of apparatuses. Also, the description of the exemplary embodiments is intended to be illustrative, and not to limit the scope of the claims, and many alternatives, modifications, and variations will be apparent to those skilled in the art.

Although a few embodiments have been shown and described, it would be appreciated by those skilled in the art that changes may be made in these embodiments without departing from the principles and spirit of the embodiments, the scope of which is defined in the claims and their equivalents.

What is claimed is:

1. A remote control apparatus for controlling a display apparatus, the remote control apparatus comprising:
a communicator configured to perform communication with the display apparatus;
a user interface provided with a plurality of control surfaces each mapped to each of a plurality of display areas provided on a screen of the display apparatus; and
a processor configured, in response to a user command being input through at least one of the plurality of control surfaces, to transmit a signal for controlling a display area mapped to a control surface with respect to which the user command has been input.

2. The remote control apparatus according to claim 1,
wherein the user interface has a structure where the plurality of control surfaces are physically divided.

3. The remote control apparatus according to claim 2,
wherein the user interface has an arch structure where a first control surface adjacent to a second control surface forms a predetermined angle with the second control surface, and a third control surface adjacent to the first control surface forms a predetermined angle with the first control surface.

4. The remote control apparatus according to claim 1,
wherein the processor transmits a signal for controlling a UI (User Interface) screen displayed on a display area mapped with a control surface where the user command has been input relative to a plurality of UI screens provided in each of the plurality of display areas.

5. The remote control apparatus according to claim 1,
further comprising a mode state detector configured to determine an arrangement state of the remote control apparatus, and to detect one of a length mode state and a width mode state according to the arrangement state,
wherein the processor controls to display a UI (user interface) screen corresponding to a detected mode state on each of the plurality of control surfaces.

6. The remote control apparatus according to claim 5,
wherein the user interface comprises a light emitter provided on a bottom part of the plurality of control surfaces, and
the processor controls the light emitter where an item representing a function corresponding to the detected mode state emits light and provides the UI screen corresponding to each of the plurality of control surfaces.

7. The remote control apparatus according to claim 1,
wherein the plurality of control surfaces comprise at least one of a key pad, touch pad and track pad.

8. A method for controlling a remote control apparatus having a plurality of control surfaces each mapped with a plurality of display areas provided on a screen of a display apparatus, the method comprising:
receiving input of a user command through at least one of the plurality of control surfaces; and
transmitting a signal for controlling a display area mapped to a control surface with respect to which the user command has been input according to the user command to the display apparatus.

9. The method according to claim 8,
wherein the transmitting involves transmitting a signal for controlling a UI (user interface) screen displayed on a display area mapped with the control surface with respect to which the user command has been input of among UIs provided in each of the plurality of display areas.

10. The method according to claim 8,
further comprising determining an arrangement state of the remote control apparatus, and detecting one of a length mode state and width mode state according to the arrangement state; and
controlling a UI (User Interface) screen corresponding to a mode state to be displayed on each of the plurality of control surfaces.

11. A display apparatus being controlled by a remote control apparatus, the display apparatus comprising:
a display configured to provide a screen;
a communicator configured to perform communication with a remote control apparatus provided with a plurality of control surfaces being mapped to each of a plurality of display areas provided on the screen; and
a processor configured, in response to receiving a control signal corresponding to a user command being input through at least one of the plurality of control surfaces provided in the remote control apparatus, to control a display area corresponding to the control signal among the plurality of display areas.

12. The display apparatus according to claim 11,
wherein the processor controls a UI (User Interface) screen corresponding to the control signal received from the remote control apparatus among a plurality of UI screens provided in each of the plurality of display areas.

13. The display apparatus according to claim 12,
wherein the processor divides the screen into a plurality of display areas in one of a length direction and a width direction based on attributes of the UI screen to be displayed on the screen and provides the UI screen.

14. The display apparatus according to claim 12,
wherein the processor, in response to receiving a touch control signal according to a touch input crossing the plurality of control surfaces of the remote control apparatus, controls where different UI screens are sequentially displayed on each of the plurality of display areas.

15. The display apparatus according to claim 12,
wherein the processor, in response to receiving a press control signal according to a press input from the remote control apparatus, controls where at least a portion of the different UI screens are displayed at a same time on each of the plurality of display areas based on a press input method.

16. A method for controlling a display apparatus, the method comprising:
performing communication with a remote control apparatus provided with a plurality of control surfaces each mapped to a plurality of display areas provided on a display screen; and
in response to receiving a control signal corresponding to a user command being input through at least one of the plurality of control surfaces provided in the remote control apparatus, controlling a display area corresponding to the control signal among the plurality of display areas.

17. The method according to claim 16,
wherein the controlling controls a UI (User Interface) screen corresponding to the control signal received from the remote control apparatus among a plurality of UI screens provided on each of the plurality of display areas.

18. The method according to claim 17,
further comprising dividing the screen into a plurality of display areas in one of a length direction and a width direction based on attributes of the UI screen to be displayed on the screen.

19. A remote control system including a remote control apparatus and display apparatus, the remote control system comprising:
the remote control apparatus provided with a plurality of control surfaces each mapped to each of a plurality of display areas provided on a screen of the display apparatus, and configured to transmit a control signal, corresponding to a user command being input through at least one of the plurality of control surfaces, to the display apparatus; and
a display apparatus configured, in response to receiving the control signal, to control a display area corresponding to the control signal among the plurality of display areas.

20. A non-transitory computer readable medium storing a process for controlling a display apparatus, the process comprising:
performing communication with a remote control apparatus provided with a plurality of control surfaces each mapped to a plurality of display areas provided on a display screen; and
in response to receiving a control signal corresponding to a user command being input through at least one of the plurality of control surfaces provided in the remote control apparatus, controlling a display area corresponding to the control signal among the plurality of display areas.
